(19) United States
(12) Patent Application Publication
(10) Pub. No.: US 2023/0262832 A1
(43) Pub. Date: Aug. 17, 2023

(54) DISCONTINUOUS RECEPTION CYCLE ALIGNMENT

(71) Applicant: QUALCOMM Incorporated, San Diego, CA (US)

(72) Inventors: Kaidong WANG, San Diego, CA (US); Jelena DAMNJANOVIC, Del Mar, CA (US); Tao LUO, San Diego, CA (US)

(21) Appl. No.: 17/651,477

(22) Filed: Feb. 17, 2022

(51) Int. Cl. H04W 76/28; H04W 72/10

(52) U.S. Cl. CPC H04W 76/28; H04W 72/10

(57) ABSTRACT

Various aspects of the present disclosure generally relate to wireless communication. In some aspects, a first user equipment (UE) may receive, from a network entity, configuration information for a group-based discontinuous reception (DRX) cycle indicating one or more on durations associated with the group-based DRX cycle. The first UE may communicate, with a second UE, during an added on duration that is not included in the one or more on durations associated with the group-based DRX cycle, wherein the added on duration at least partially overlaps with an on duration associated with the second UE. Numerous other aspects are described.

### FIELD OF THE DISCLOSURE

Aspects of the present disclosure generally relate to wireless communication and to techniques and apparatuses for discontinuous reception (DRX) cycle alignment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first user equipment (UE) for wireless communication. The first UE may include a memory and one or more processors coupled to the memory. The one or more processors may be configured to receive, from a network entity, configuration information for a group-based discontinuous reception (DRX) cycle indicating one or more on durations associated with the group-based DRX cycle. The one or more processors may be configured to communicate, with a second UE, during an added on duration that is not included in the one or more on durations associated with the group-based DRX cycle, wherein the added on duration at least partially overlaps with an on duration associated with the second UE.

Some aspects described herein relate to a network entity for wireless communication. The network entity may include a memory and one or more processors coupled to the memory. The one or more processors may be configured to configure, for a first group of UEs, a first group-based DRX cycle indicating one or more on durations associated with the first group-based DRX cycle. The one or more processors may be configured to transmit an indication of an added on duration for a UE, included in the first group of UEs, that is not included in the one or more on durations associated with the first group-based DRX cycle, wherein the added on duration at least partially overlaps with an on duration associated with a second group-based DRX cycle.

Some aspects described herein relate to a method of wireless communication performed by a first UE. The method may include receiving, from a network entity, configuration information for a group-based DRX cycle indicating one or more on durations associated with the group-based DRX cycle. The method may include communicating, with a second UE, during an added on duration that is not included in the one or more on durations associated with the group-based DRX cycle, wherein the added on duration at least partially overlaps with an on duration associated with the second UE.

Some aspects described herein relate to a method of wireless communication performed by a network entity. The method may include configuring, for a first group of UEs, a first group-based DRX cycle indicating one or more on durations associated with the first group-based DRX cycle. The method may include transmitting an indication of an added on duration for a UE, included in the first group of UEs, that is not included in the one or more on durations associated with the first group-based DRX cycle, wherein the added on duration at least partially overlaps with an on duration associated with a second group-based DRX cycle.

Some aspects described herein relate to a non-transitory computer-readable medium that stores a set of instructions for wireless communication by a first UE. The set of instructions, when executed by one or more processors of the first UE, may cause the first UE to receive, from a network entity, configuration information for a group-based DRX cycle indicating one or more on durations associated with the group-based DRX cycle. The set of instructions, when executed by one or more processors of the first UE, may cause the first UE to communicate, with a second UE, during an added on duration that is not included in the one or more on durations associated with the group-based DRX cycle, wherein the added on duration at least partially overlaps with an on duration associated with the second UE.

Some aspects described herein relate to a non-transitory computer-readable medium that stores a set of instructions for wireless communication by a network entity. The set of instructions, when executed by one or more processors of the network entity, may cause the network entity to configure, for a first group of UEs, a first group-based DRX cycle indicating one or more on durations associated with the first group-based DRX cycle. The set of instructions, when executed by one or more processors of the network entity, may cause the network entity to transmit an indication of an added on duration for a UE, included in the first group of UEs, that is not included in the one or more on durations associated with the first group-based DRX cycle, wherein the added on duration at least partially overlaps with an on duration associated with a second group-based DRX cycle.

Some aspects described herein relate to a first apparatus for wireless communication. The first apparatus may include means for receiving, from a network entity, configuration information for a group-based DRX cycle indicating one or more on durations associated with the group-based DRX cycle. The first apparatus may include means for communicating, with a second apparatus, during an added on duration that is not included in the one or more on durations associated with the group-based DRX cycle, wherein the added on duration at least partially overlaps with an on duration associated with the second apparatus.

Some aspects described herein relate to an apparatus for wireless communication. The apparatus may include means for configuring, for a first group of UEs, a first group-based DRX cycle indicating one or more on durations associated with the first group-based DRX cycle. The apparatus may include means for transmitting an indication of an added on duration for a UE, included in the first group of UEs, that is not included in the one or more on durations associated with the first group-based DRX cycle, wherein the added on duration at least partially overlaps with an on duration associated with a second group-based DRX cycle.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of a discontinuous reception (DRX) configuration, in accordance with the present disclosure.

FIGS. 7A and 7B are diagrams illustrating an example of group-based DRX cycle configurations, in accordance with the present disclosure.

FIGS. 8A-8C are diagrams illustrating an example of DRX cycle alignment, in accordance with the present disclosure.

FIG. 9 is a diagram illustrating an example process performed, for example, by a first UE, in accordance with the present disclosure.

FIG. 10 is a diagram illustrating an example process performed, for example, by a network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

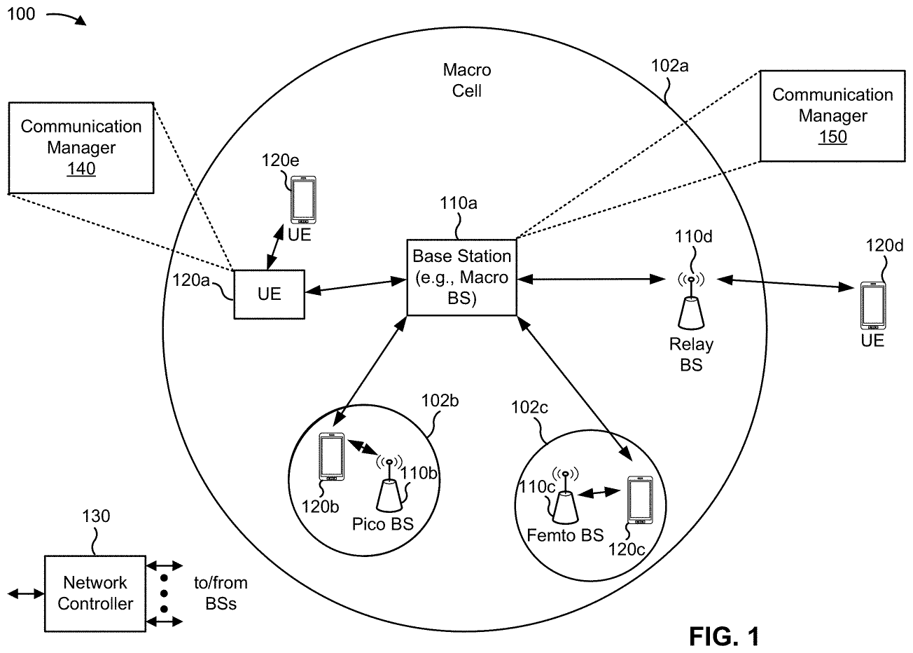

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, the term “base station” (e.g., the base station 110) or “network entity” may refer to an aggregated base station, a disaggregated base station, an integrated access and backhaul (IAB) node, a relay node, and/or one or more components thereof. For example, in some cases, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some examples, the term “base station” or “network entity” may refer to one device configured to perform one or more functions, such as those described herein in connection with the base station 110. In some examples, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some examples, the term “base station” or “network entity” may refer to one or more virtual base stations and/or one or more virtual base station functions. For example, in some examples, two or more base station functions may be instantiated on a single device. In some examples, the term “base station” or “network entity” may refer to one of the base station functions and not another. In this way, a single device may include more than one base station. A network entity referred to herein may include hardware, software, and/or a combination of hardware and software.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network entity, configuration information for a group-based discontinuous reception (DRX) cycle indicating one or more on durations associated with the group-based DRX cycle; and communicate, with a second UE, during an added on duration that is not included in the one or more on durations associated with the group-based DRX cycle, wherein the added on duration at least partially overlaps with an on duration associated with the second UE. Additionally, or alternatively, the communication manager 140 may perform one or more other operations described herein.

In some aspects, the base station 110 may include a communication manager 150. As described in more detail elsewhere herein, the communication manager 150 may configure, for a first group of UEs, a first group-based DRX cycle indicating one or more on durations associated with the first group-based DRX cycle; and transmit an indication of an added on duration for a UE, included in the first group of UEs, that is not included in the one or more on durations associated with the first group-based DRX cycle, wherein the added on duration at least partially overlaps with an on duration associated with a second group-based DRX cycle. Additionally, or alternatively, the communication manager 150 may perform one or more other operations described herein.

As indicated above, FIG. 1 is provided as an example. Other examples may differ from what is described with regard to FIG. 1.

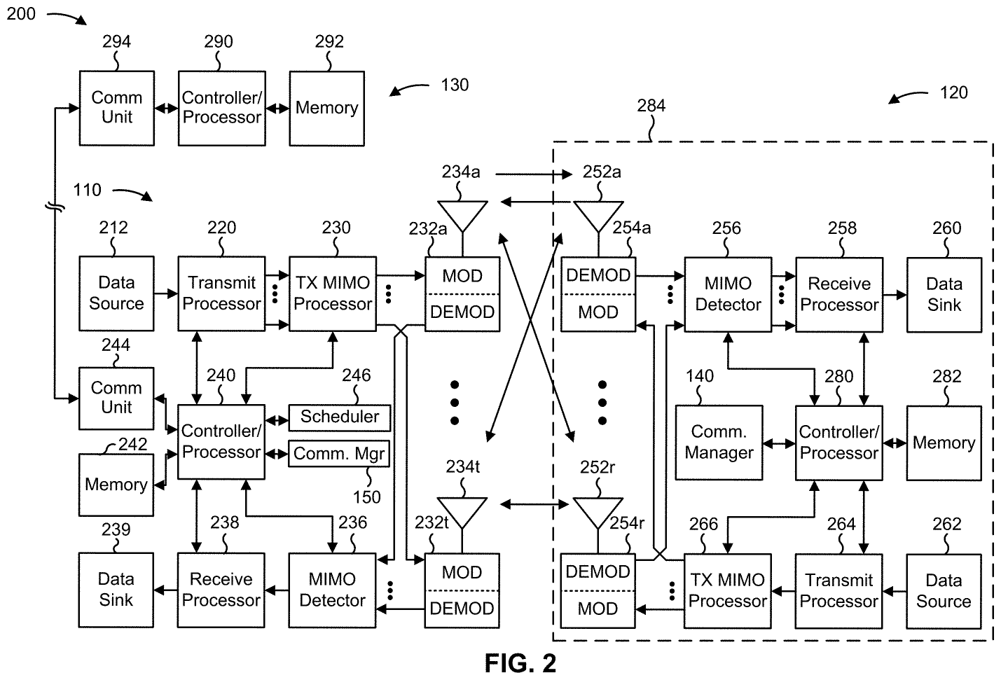

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

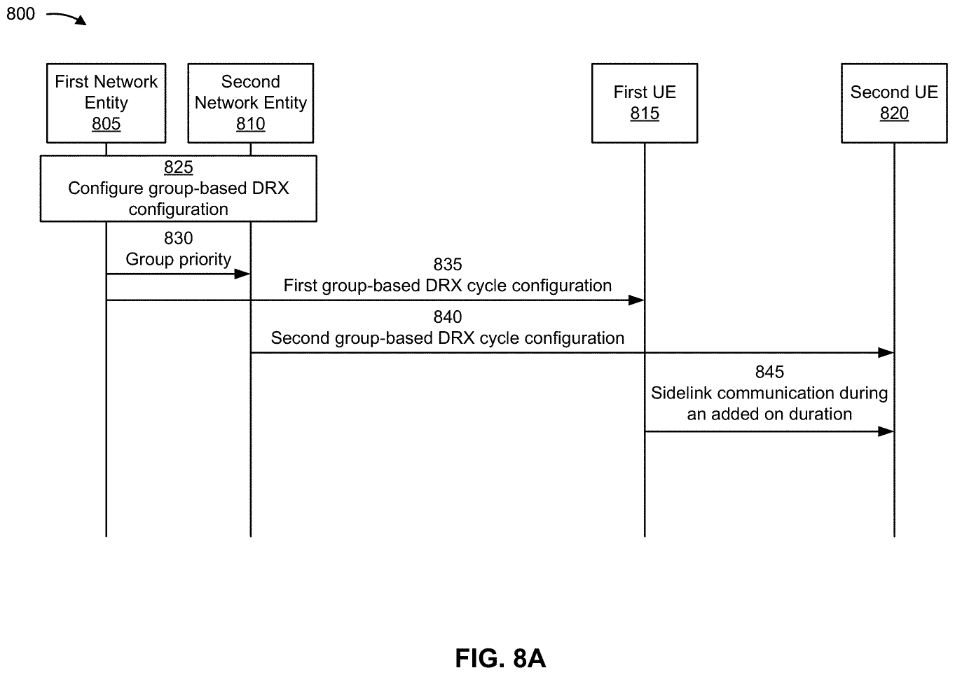

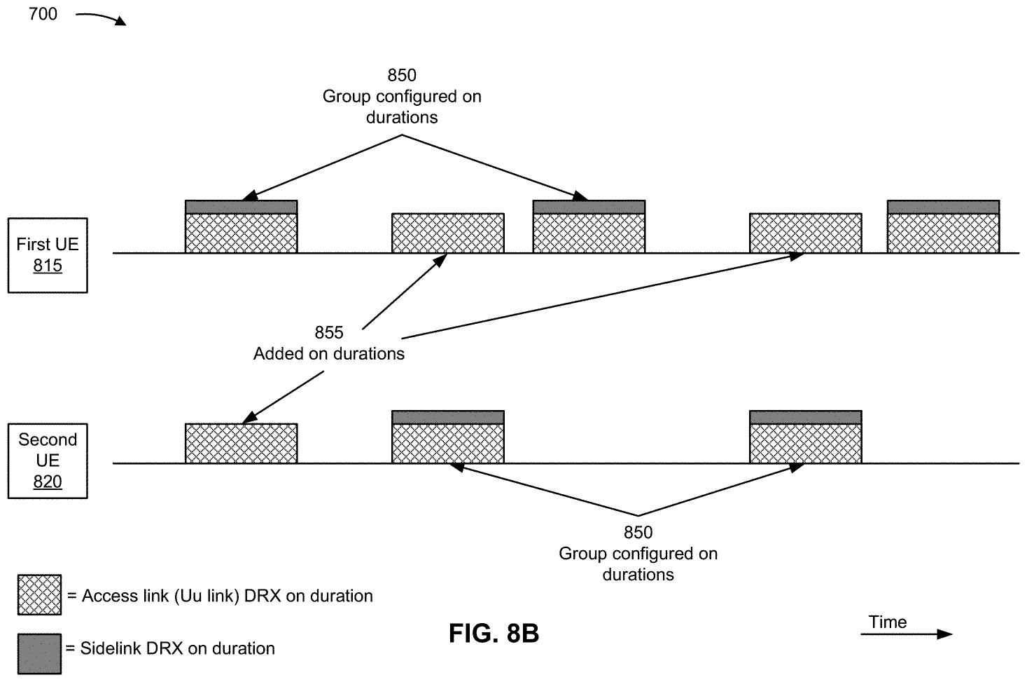

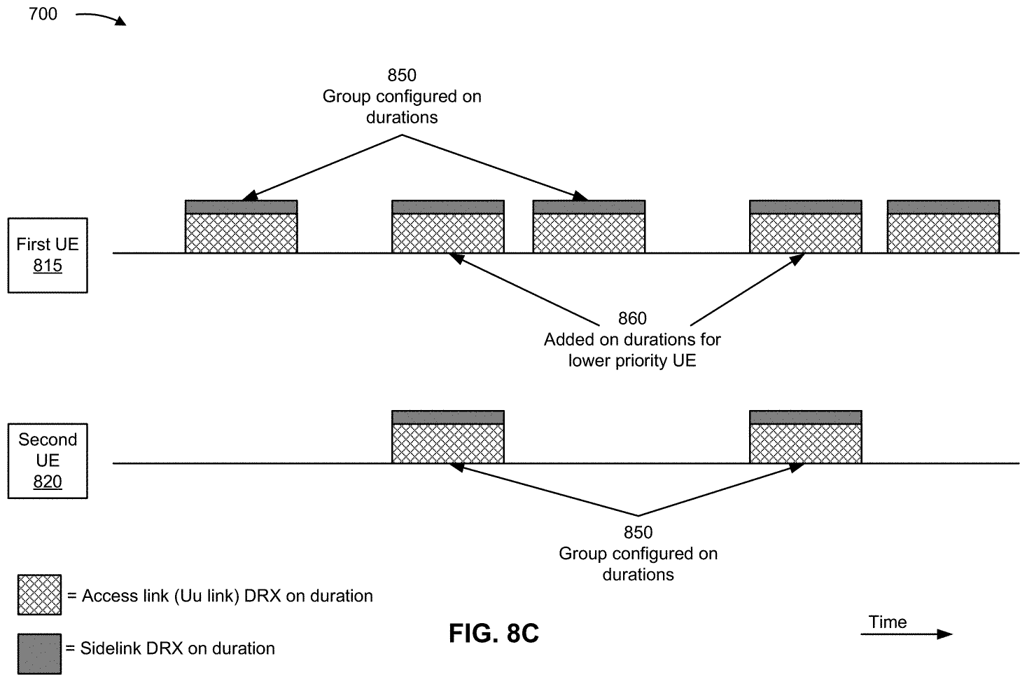

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8A-8C, 9, 10, 11, and 12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8A-8C, 9, 10, 11, and 12).

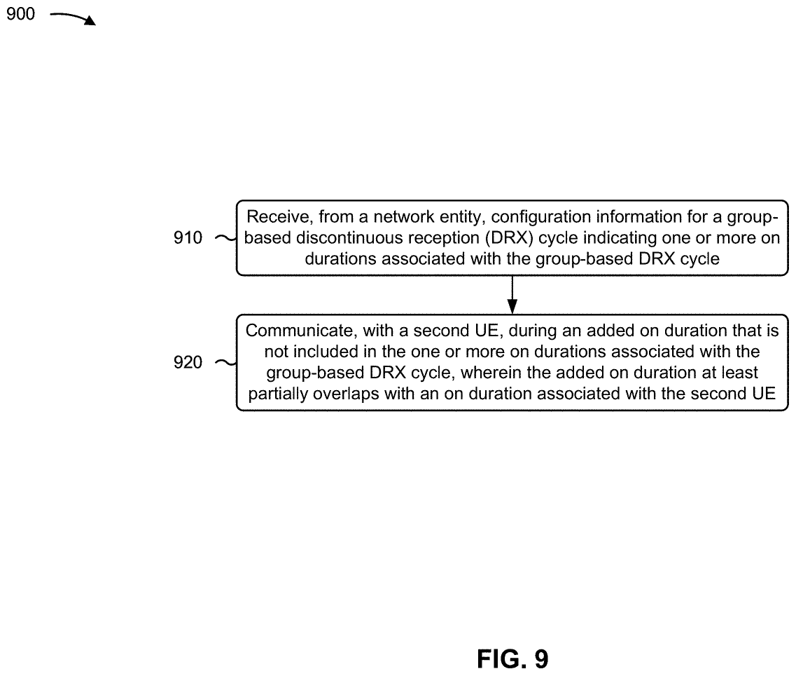

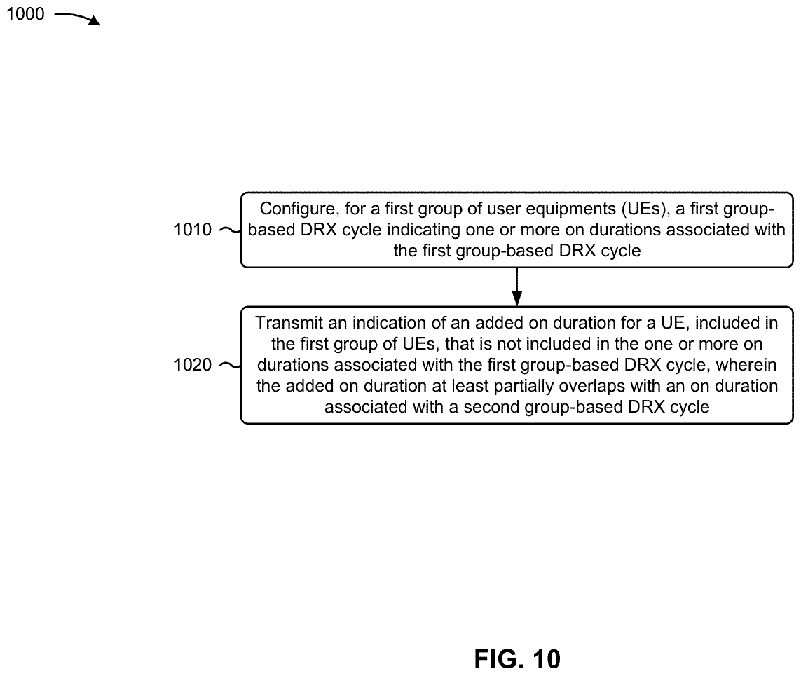

The controller/processor 240 of the base station 110, the controller/processor 280 of the UE 120, and/or any other component(s) of FIG. 2 may perform one or more techniques associated with DRX cycle alignment, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving, from a network entity, configuration information for a group-based discontinuous reception (DRX) cycle indicating one or more on durations associated with the group-based DRX cycle (e.g., using antenna 252, DEMOD 254, MIMO detector 256, receive processor 258, controller/processor 280, and/or memory 282); and/or means for communicating, with a second UE, during an added on duration that is not included in the one or more on durations associated with the group-based DRX cycle, wherein the added on duration at least partially overlaps with an on duration associated with the second UE (e.g., using antenna 252, DEMOD 254, MIMO detector 256, receive processor 258, controller/processor 280, and/or memory 282 or using controller/processor 280, transmit processor 264, TX MIMO processor 266, MOD 254, antenna 252, and/or memory 282). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity includes means for configuring, for a first group of UEs, a first group-based DRX cycle indicating one or more on durations associated with the first group-based DRX cycle (e.g., using controller/processor 240 and/or memory 242); and/or means for transmitting an indication of an added on duration for a UE, included in the first group of UEs, that is not included in the one or more on durations associated with the first group-based DRX cycle, wherein the added on duration at least partially overlaps with an on duration associated with a second group-based DRX cycle (e.g., using controller/processor 240, transmit processor 220, TX MIMO processor 230, MOD 232, antenna 234, and/or memory 242). In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

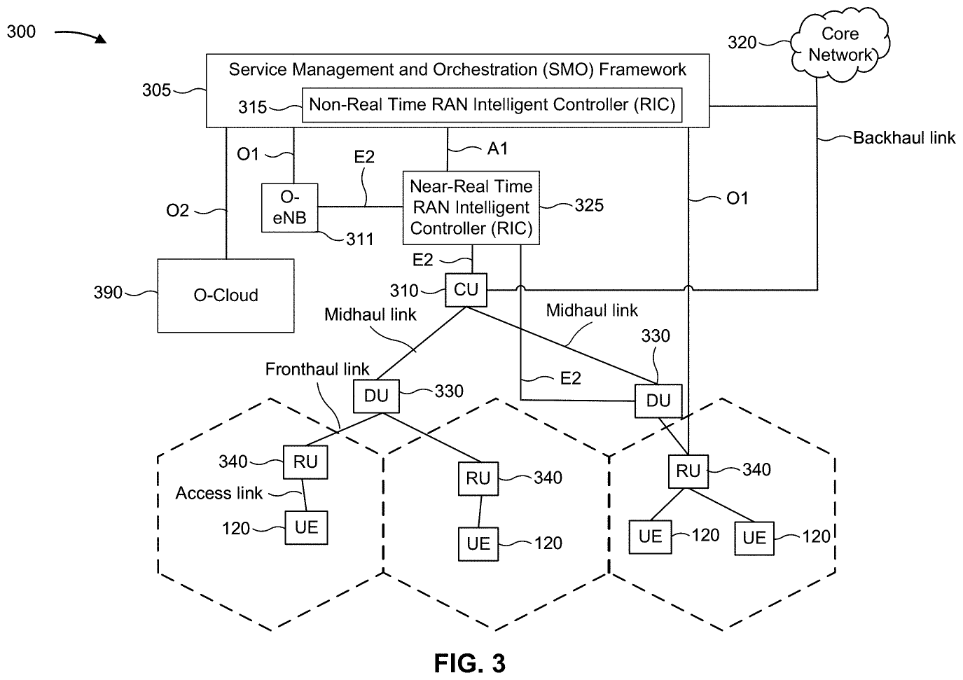

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (e.g., base station 110), or one or more units (or one or more components) performing base station functionality, may be implemented in an aggregated or disaggregated architecture. For example, a base station (such as a Node B (NB), eNB, NR base station, 5G NB, access point (AP), a TRP, a cell, or the like) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (MC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

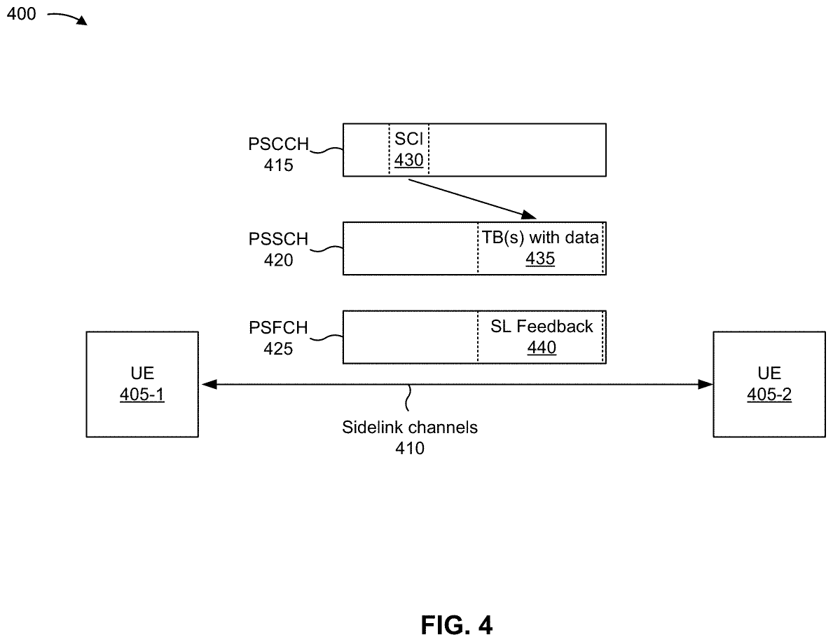

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some examples, the UEs 405 (e.g., UE 405-1 and/or UE 405-2) may correspond to one or more other UEs described elsewhere herein, such as UE 120. In some examples, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 via an access link or an access channel. The PSSCH 420 may be used to communicate data, similar to a physical downlink shared channel (PDSCH) and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARD) feedback (e.g., acknowledgement or negative acknowledgement (ACK/NACK) information), transmit power control (TPC), and/or a scheduling request (SR).

Although shown on the PSCCH 415, in some examples, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARM) process ID, a new data indicator (NDI), a source identifier, a destination identifier, and/or a channel state information (CSI) report trigger.

In some examples, the one or more sidelink channels 410 may use resource pools. For example, a scheduling assignment (e.g., included in SCI 430) may be transmitted in sub-channels using specific resource blocks (RBs) across time. In some examples, data transmissions (e.g., on the PSSCH 420) associated with a scheduling assignment may occupy adjacent RBs in the same subframe as the scheduling assignment (e.g., using frequency division multiplexing). In some examples, a scheduling assignment and associated data transmissions are not transmitted on adjacent RBs.

In some examples, a UE 405 may operate using a sidelink transmission mode (e.g., Mode 1) where resource selection and/or scheduling is performed by a base station 110. For example, the UE 405 may receive a grant (e.g., in downlink control information (DCI) or in a radio resource control (RRC) message, such as for configured grants) from the base station 110 for sidelink channel access and/or scheduling. In some examples, a UE 405 may operate using a transmission mode (e.g., Mode 2) where resource selection and/or scheduling is performed by the UE 405 (e.g., rather than a base station 110). In some examples, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy rate (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some examples, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

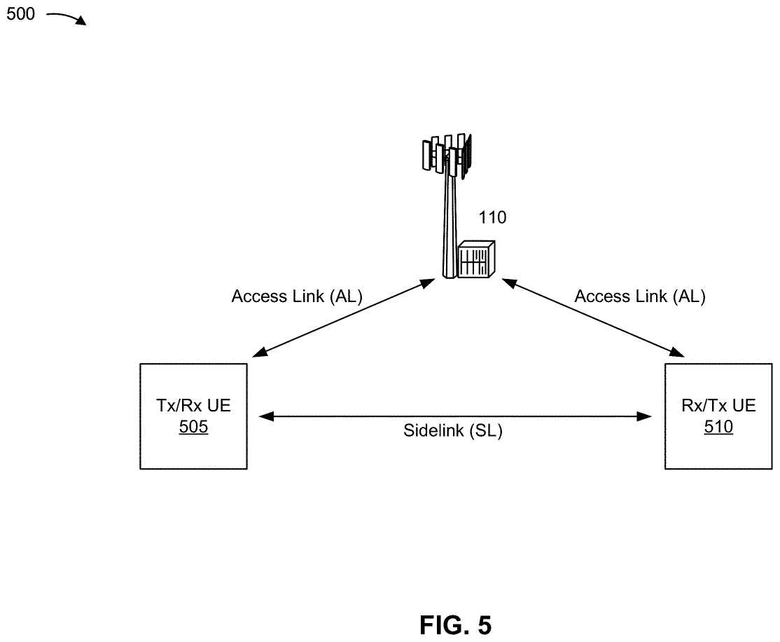

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a base station 110 may communicate with the Tx/Rx UE 505 via a first access link. Additionally, or alternatively, in some sidelink modes, the base station 110 may communicate with the Rx/Tx UE 510 via a second access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 5 is provided as an example. Other examples may differ from what is described with respect to FIG. 5.

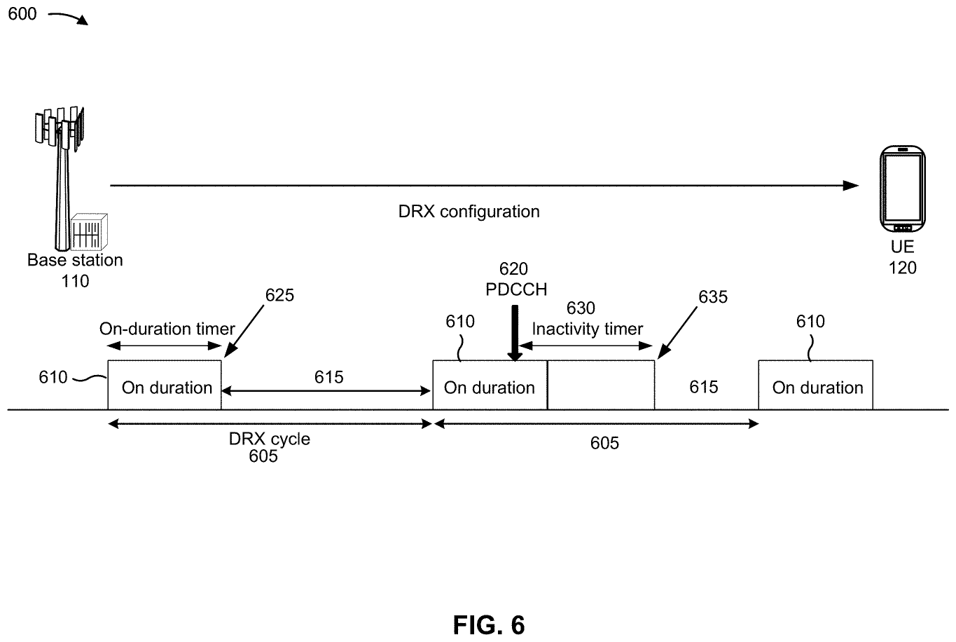

FIG. 6 is a diagram illustrating an example 600 of a DRX configuration, in accordance with the present disclosure.

As shown in FIG. 6, a base station 110 may transmit a DRX configuration to a UE 120 to configure a DRX cycle 605 for the UE 120. A DRX cycle 605 may include a DRX on duration 610 (e.g., during which a UE 120 is awake or in an active state) and an opportunity to enter a DRX sleep state 615. As used herein, the time during which the UE 120 is configured to be in an active state during the DRX on duration 610 may be referred to as an active time or an on duration, and the time during which the UE 120 is configured to be in the DRX sleep state 615 may be referred to as an inactive time or an off duration. As described below, the UE 120 may monitor a PDCCH during the active time, and may refrain from monitoring the PDCCH during the inactive time.

During the DRX on duration 610 (e.g., the active time), the UE 120 may monitor a downlink control channel (e.g., a PDCCH), as shown by reference number 620. For example, the UE 120 may monitor the PDCCH for downlink control information (DCI) pertaining to the UE 120. If the UE 120 does not detect and/or successfully decode any PDCCH communications intended for the UE 120 during the DRX on duration 610, then the UE 120 may enter the sleep state 615 (e.g., for the inactive time) at the end of the DRX on duration 610, as shown by reference number 625. In this way, the UE 120 may conserve battery power and reduce power consumption. As shown, the DRX cycle 605 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 630 (e.g., which may extend the active time). The UE 120 may start the DRX inactivity timer 630 at a time at which the PDCCH communication is received (e.g., in a transmission time interval (TTI) in which the PDCCH communication is received, such as a slot or a subframe). The UE 120 may remain in the active state until the DRX inactivity timer 630 expires, at which time the UE 120 may enter the sleep state 615 (e.g., for the inactive time), as shown by reference number 635. During the duration of the DRX inactivity timer 630, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 630 after each detection of a PDCCH communication for the UE 120 for an initial transmission (e.g., but not for a retransmission). By operating in this manner, the UE 120 may conserve battery power and reduce power consumption by entering the sleep state 615.

In some examples, the UE 120 may be configured with a DRX configuration for a sidelink. For example, a sidelink DRX configuration may include a sidelink DRX on duration (e.g., similar to the DRX on duration 610) and an opportunity to enter a sidelink DRX sleep state, in a similar manner as described above. For example, during an on duration of a sidelink DRX cycle, the UE 120 may monitor a sidelink control channel (e.g., a PSCCH). In some examples, the UE 120 may be configured with a DRX cycle for an access link with a base station (e.g., for a Uu link) and a DRX cycle for a sidelink. In some examples, a base station or other network entity (e.g., a DU or a CU) may configure a Uu DRX cycle and a sidelink DRX cycle for a UE 120 to be aligned. As used herein, two or more DRX cycles may be aligned if the on durations of the two or more DRX cycles at least partially overlap in the time domain.

In some cases, alignment of DRX cycles may be associated with a communication direction. For example, when two UEs are communication via a sidelink, one UE may be a transmitting UE and the other UE may be a receiving UE. A first type of alignment may consider whether an access link (e.g., Uu link) DRX cycle for the transmitting UE is aligned with a sidelink DRX cycle of the receiving UE. A second type of alignment may consider whether, for a given UE, an access link (e.g., Uu link) DRX cycle for the given UE is aligned with the sidelink DRX cycle for the given UE. When a UE is operating in the Mode 1 transmission mode for sidelink communications, the first type of alignment and the second type of alignment may facilitate sidelink communications because the transmitting UE receives a sidelink grant from a network entity (e.g., during an on duration of the Uu DRX cycle of the transmitting UE) and the receiving UE may receive a sidelink message indicated by the sidelink grant during an on duration of the sidelink DRX cycle of the receiving UE. In some examples, two UEs may be considered to be aligned if both the first type of alignment and the second type of alignment are satisfied. For example, for a pair of UEs, in a first transmission direction, DRX alignment may be based at least in part on a first UE's Uu DRX cycle aligning with a sidelink DRX cycle of a second UE and a Uu DRX cycle of the second UE aligning with the sidelink DRX cycle of the second UE. For the pair of UEs, in a second transmission direction, DRX alignment may be based at least in part on the Uu DRX cycle of the second UE aligning with a sidelink DRX cycle of the first UE and the Uu DRX cycle of the first UE aligning with the sidelink DRX cycle of the first UE. In some examples, the pair of UEs may be considered to have aligned DRX cycles based at least in part on the above conditions being met for both transmission directions.

As indicated above, FIG. 6 is provided as an example. Other examples may differ from what is described with respect to FIG. 6.

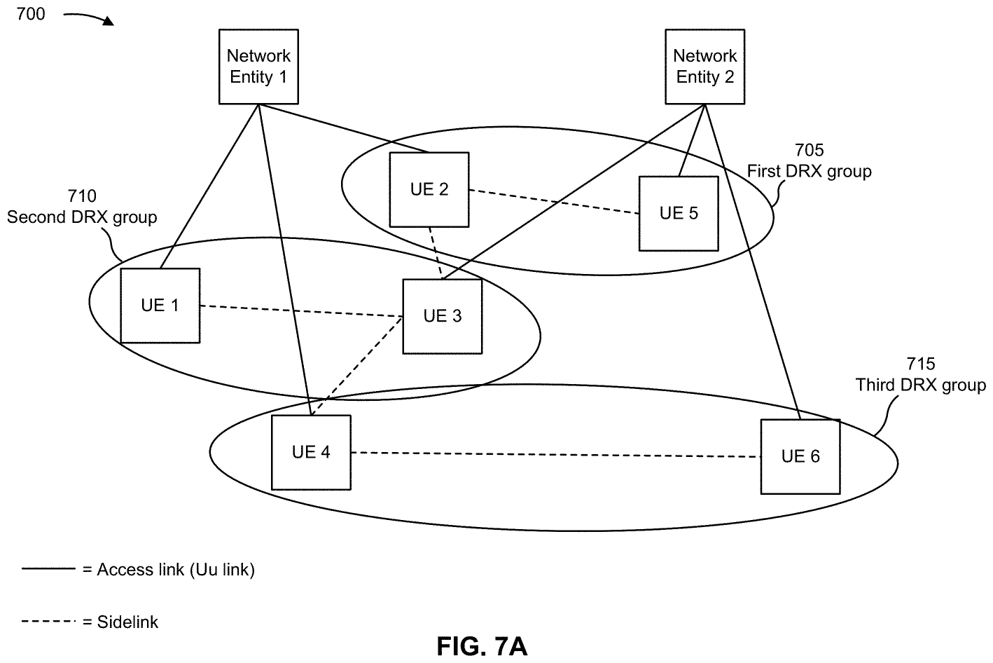

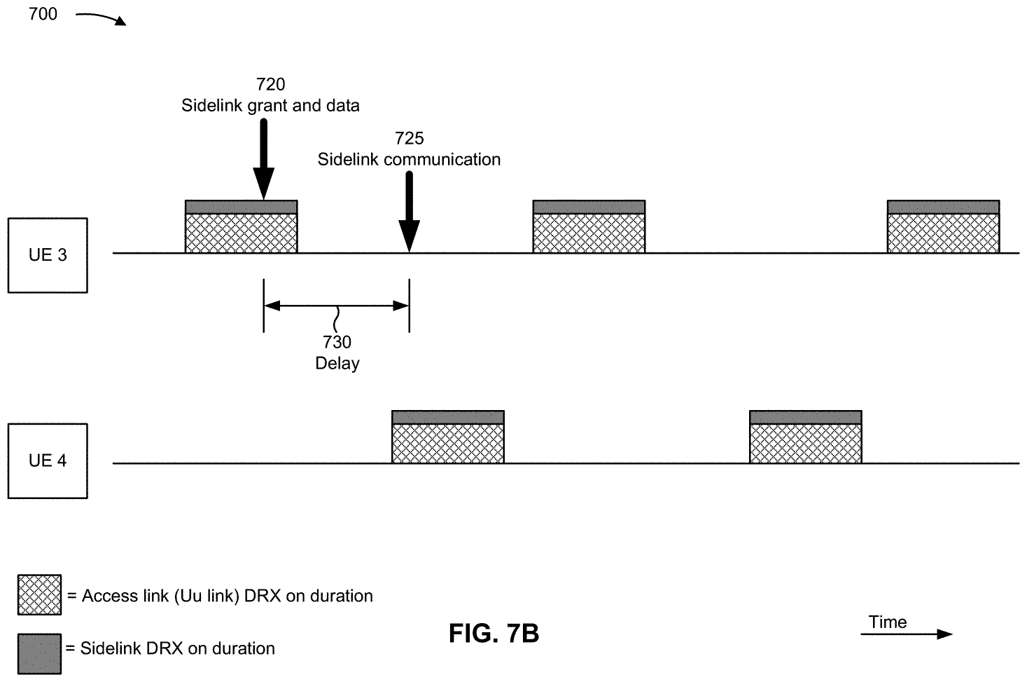

FIGS. 7A and 7B are diagrams illustrating an example 700 of group-based DRX cycle configurations, in accordance with the present disclosure. As shown in FIG. 7A, a first network entity (e.g., network entity 1) and a second network entity (e.g., network entity 2) and a group of UEs (e.g., UE 1, UE 2, UE 3, UE 4, UE 5, and UE 6) may communicate in a wireless network, such as the wireless network 100. The first network entity and the second network entity may be base stations, DU, CUs, or other entities. As shown in FIG. 7A, the first network entity may establish Uu links (e.g., access links) with the first UE (e.g., UE 1), the second UE (e.g., UE 2), and the fourth UE (e.g., UE 4). The second network entity may establish Uu links (e.g., access links) with the third UE (e.g., UE 3), the fifth UE (e.g., UE 5) and the sixth UE (e.g., UE 6). In some examples, the first network entity and the second network entity may communicate with each other (e.g., via an Xn interface).

As shown in FIG. 7A, the UEs may communicate with one another via various sidelink connections. For example, the UE 1 and the UE 3 may establish a sidelink connection, the UE 2 and the UE 3 may establish a sidelink connection, the UE 2 and the UE 5 may establish a sidelink connection, the UE 3 and the UE 4 may establish a sidelink connection, and the UE 4 and the UE 6 may establish a sidelink connection. In a similar manner as described above, the network entities may configure different DRX cycles for the various communication links in the wireless network. For example, the network entities may configure access link (e.g., Uu) DRX cycles for the UEs and/or sidelink DRX cycles for the UEs.

In some examples, the network entities may use group-based DRX cycle configurations. For example, UEs included in a group may be associated with the same DRX cycle(s). For example, the UEs included in the first DRX group 705 (e.g., the UE 2 and the UE 5) may be associated with the same DRX cycle(s). The UEs included in the second DRX group 710 (e.g., the UE 1 and the UE 3) may be associated with the same DRX cycle(s). Similarly, the UEs included in the third DRX group 715 (e.g., the UE 4 and the UE 6) may be associated with the same DRX cycle(s). In some examples, the network entities may configure the DRX groups such that Uu DRX cycles and sidelink DRX cycles for UEs included in the same group are aligned (e.g., at least partially overlap in the time domain).

The network entities may use group-based DRX cycle configurations to improve resource utilization within the wireless network. For example, rather than all UEs in the wireless network having the same configured on duration (e.g., with all UEs monitoring control channels during the same period of time), there may be periods of time with high network activity (e.g., during the configured on durations) and periods of time with little or no network activity (e.g., during inactive times). However, by grouping the UEs, the network entities can stagger on durations of DRX cycles of different groups, such that the activity and load on the network are more evenly distributed over time. For example, the UEs included in the first DRX group 705 may have a first on duration configured at a first time and with a first periodicity, the UEs included in the second DRX group 710 may have a second on duration configured at a second time and with a second periodicity, and the UEs included in the third DRX group 715 may have a third on duration configured at a third time and with a third periodicity. In this way, the periods of time in which UEs are on (e.g., monitoring control channels) in the wireless network may be staggered or distributed over time, thereby improving resource utilization within the wireless network.

In some cases, UEs in different groups may communicate with one another (e.g., via a sidelink). For example, as shown in FIG. 7A, the UE 3 may communicate with the UE 4. However, because the UE 3 and the UE 4 are in different DRX groups, various DRX cycles for the UE 3 and the UE 4 may not be aligned. For example, if the UE 3 is a transmitter and the UE 4 is a receiver, the Uu DRX on duration of the UE 3 may not be aligned with the sidelink on duration of the UE 4. As another example, if the UE 4 is a transmitter and the UE 3 is a receiver, the Uu DRX on duration of the UE 4 may not be aligned with the sidelink on duration of the UE 3. Misalignment of DRX cycles (e.g., of on durations of DRX cycles) of UEs communicating via a sidelink connection may result in increased latency and/or power consumption by the UEs, as described in more detail below.

For example, as shown in FIG. 7B and by reference number 720, the UE 3 may receive (e.g., from the second network entity) a sidelink grant and/or sidelink data to be transmitted to the UE 4. For example, the UE 3 may receive the sidelink grant (e.g., via a PDCCH message) during an on duration associated with an access link DRX cycle configured for the UE 3. However, as shown in FIG. 7B, the on duration associated with the access link DRX cycle configured for the UE 3 may not align with an on duration for a sidelink DRX cycle configured for the UE 4. In other words, if the UE 3 were to transmit a sidelink communication (e.g., that is scheduled by the sidelink grant) shortly after receiving the sidelink grant (e.g., during an on duration of a sidelink DRX cycle configured for the UE 3), then the sidelink communication may not be received by the UE 4 because the UE 4 may not be monitoring the sidelink channel during this time. Instead, as shown by reference number 725, the UE 3 may transmit the sidelink communication to the UE 4 at a later time (e.g., may delay the sidelink communication, as shown by reference number 730). For example, the second network entity may be required to schedule the UE 3 to transmit the sidelink communication at a later time such that the transmission of the sidelink communication occurs during the on duration for the sidelink DRX cycle configured for the UE 4.

This may increase a latency associated with the sidelink communication due to the delay in transmission of the sidelink communication (e.g., shown by reference number 730). Additionally, this may increase power consumption for the UE 3 because the UE 3 may be required to transition out of a sleep state or an inactive state to transmit the sidelink communication (e.g., because the transmission occurs outside of the on duration of the sidelink DRX cycle configured for the UE 3).

Some techniques and apparatuses described herein enable DRX cycle alignment (e.g., for UEs included in different groups associated with group-based DRX cycle configurations). For example, a UE may receive configuration information for a group-based DRX cycle indicating one or more on durations associated with the group-based DRX cycle. The UE may communicate, with another UE, during an added on duration that is not included in the one or more on durations associated with the group-based DRX cycle. The added on duration may at least partially overlap with an on duration associated with the other UE. As a result, latency associated with sidelink communications between the UEs may be decreased because the added on duration may enable a sidelink grant and a sidelink communication to be transmitted or received during the same on duration. Additionally, the transmission of sidelink communications may occur during an on duration for each UE, thereby eliminating the need for at least one of the UEs to transition out of a sleep state or an inactive state to transmit or receive the sidelink communication(s).

In some aspects, the UE and the other UE may be in different groups for group-based DRX cycle configurations. In some aspects, the added on duration is associated with a first link type, from a sidelink or an access link, and the on duration associated with the other UE is associated with a second link type, from the sidelink or the access link. In some aspects, the UE adding the on duration may be based at least in part on the UE and/or the group associated with the UE being associated with a lower priority than the other UE and/or the group associated with the other UE. For example, one or more network entities may configure groups for group-based DRX cycle configurations. Each group may be associated with a priority level and all UEs included in a group may be associated with the same priority level as the group. The one or more network entities may align DRX cycles (e.g., Uu DRX cycles and sidelink DRX cycles) for UEs within the group associated with the highest priority first, followed by UEs within the group associated with the second highest priority, and so on. When UEs in different groups communicate with one another, the UE that is associated with a lower priority may be associated with added on durations to align with the DRX cycle(s) of the UE that is associated with a higher priority. This may reduce power consumption for higher priority UEs (e.g., because these UEs may not be required to add on durations), while still ensuring DRX cycle alignment for UEs in different groups, for example, and thereby reducing latency associated with sidelink communications between the UEs in different groups.

FIGS. 8A-8C are diagrams illustrating an example 800 of DRX cycle alignment, in accordance with the present disclosure. As shown in FIG. 8A, a first network entity 805, a second network entity 810, a first UE 815, and a second UE 810 may communicate with one another. The first network entity 805, the second network entity 810, the first UE 815, and the second UE 810 may be part of a wireless network (e.g., the wireless network 100). The first network entity 805 and/or the second network entity 810 may be a base station (e.g., the base station 110), an IAB node, a CU, a DU, an RU, and/or another entity. The UEs and the network entities may have established a wireless connection prior to operations depicted in FIGS. 8A-8C.

As shown by reference number 825, the first network entity 805 and/or the second network entity 810 may configure one or more group-based DRX configurations. For example, the first network entity 805 and/or the second network entity 810 may configure, for a first group of UEs, a first group-based DRX cycle indicating one or more on durations associated with the first group-based DRX cycle. In some aspects, for the first group of UEs, the first network entity 805 and/or the second network entity 810 may configure a first DRX cycle for an access link (e.g., a Uu link) and a second DRX cycle for a sidelink. In some aspects, the first network entity 805 and/or the second network entity 810 may configure the first DRX cycle and the second DRX cycle to align (e.g., such that on durations of the first DRX cycle and the second DRX cycle at least partially overlap in the time domain) for UEs included in the first group of UEs. In some aspects, the first UE 815 may be included in the first group of UEs.

Additionally, the first network entity 805 and/or the second network entity 810 may configure, for a second group of UEs, a second group-based DRX cycle indicating one or more on durations associated with the second group-based DRX cycle. In some aspects, for the second group of UEs, the first network entity 805 and/or the second network entity 810 may configure a first DRX cycle for an access link (e.g., a Uu link) and a second DRX cycle for a sidelink. In some aspects, the first network entity 805 and/or the second network entity 810 may configure the first DRX cycle and the second DRX cycle to align (e.g., such that on durations of the first DRX cycle and the second DRX cycle at least partially overlap in the time domain) for UEs included in the second group of UEs. In some aspects, the second UE 820 may be included in the second group of UEs.

In some aspects, a single network entity (e.g., a CU) may configure all of the group-based DRX cycle configurations. The single network entity may transmit an indication of the group-based DRX cycle configurations to other network entities (e.g., DUs and/or RUs). In other aspects, the first network entity 805 may configure the first group-based DRX cycle configuration and the second network entity 810 may configure the second group-based DRX cycle configuration (e.g., in examples where the first network entity 805 and the second network entity 810 are base stations and/or DUs).

In some aspects, the first network entity 805 and the second network entity 810 may communicate to configure the one or more group-based DRX cycle configurations. For example, the first network entity 805 may transmit, and the second network entity 810 may receive, an indication of the first group-based DRX cycle configuration (e.g., for the first group of UEs and/or the first UE 815). Similarly, the first network entity 805 may receive, and the second network entity 810 may transmit, an indication of the second group-based DRX cycle configuration (e.g., for the second group of UEs and/or the second UE 820). For example, the first network entity 805 and the second network entity 810 may communicate via an Xn interface, an O1 interface, a midhaul link, a fronthaul link, and/or another communication interface.

In some aspects, the first network entity 805 and/or the second network entity 810 may prioritize DRX cycle alignment based at least in part on a priority associated with the UEs and/or DRX groups. For example, the first network entity 805 and/or the second network entity 810 may group UEs (e.g., for group-based DRX cycle configurations) based at least in part on a priority level associated with the UEs (e.g., UEs with the same, or similar, priority levels may be grouped together). The priority level may be based at least in part on a QoS priority value associated with the UEs, a latency requirement associated with the UEs, an amount of buffered data associated with the UEs, and/or a physical (PHY) layer priority indication, among other examples. For example, UEs that are associated with a stricter latency requirement (e.g., such as for ultra-reliable low latency communications (URLLC)) may be associated with a higher priority than UEs associated with a less strict latency requirement.

When configuring the group-based DRX cycle configurations, the first network entity 805 and/or the second network entity 810 may align first on durations associated with a sidelink with first on durations associated with an access link for a first group of UEs. The first network entity 805 and/or the second network entity 810 may align second on durations associated with the sidelink with second on durations associated with the access link for a second group of UEs. The first network entity 805 and/or the second network entity 810 may align the second on durations associated with the sidelink with the second on durations associated with the access link for a second group of UEs after aligning the first on durations associated with the sidelink with the first on durations associated with the access link for the first group of UEs, based at least in part on the first group of UEs being associated with a higher priority than the second group of UEs. In other words, the first network entity 805 and/or the second network entity 810 may make DRX alignments for UEs within the DRX group of the highest priority, followed by the DRX group of the second highest priority, and so on. For example, the first network entity 805 and/or the second network entity 810 may make DRX alignments according to a descending order of priority for different DRX groups associated with the wireless network. This may ensure that higher priority UEs and/or higher priority DRX groups are aligned (e.g., have on durations of different DRX cycles that at least partially overlap in the time domain).

In some aspects, the first network entity 805 and the second network entity 810 may communicate information associated with the group-based DRX cycle configurations. For example, as shown by reference number 830, the first network entity 805 may transmit, and the second network entity 810 may receive, an indication of a priority (e.g., a priority level) associated with a first group-based DRX cycle. For example, the first network entity 805 may transmit information associated with the first group-based DRX cycle. The information associated with the first group-based DRX cycle may include the indication of the priority associated with the first group-based DRX cycle. For example, the information associated with the first group-based DRX cycle may be included in a DRX group configuration message (e.g., the first network entity 805 may transmit a DRX group configuration message that includes the indication of the priority associated with the first group-based DRX cycle). For example, the first network entity 805 may transmit a DRX group configuration (e.g., DRXGroupConfig) information element. The DRX group configuration information element may include a DRX group priority field (e.g., a DRXGroupPriority field). In some aspects, the DRX group configuration message may be an Xn application protocol (Xn-AP) message. For example, the first network entity 805 may transmit the indication of the priority associated with the first group-based DRX cycle via an Xn interface. The indication of the priority associated with the first group-based DRX cycle may include an integer (e.g., a number) indicating the priority. For example, the priority may be indicated by an integer number (e.g., 0, 1, 2, 3, 4, and/or other numbers) included in the DRX group priority field of the DRX group configuration. In this way, the first network entity 805 and the second network entity 810 may be coordinated as to the priorities associated with different DRX groups. For example, the first network entity 805 and the second network entity 810 may communicate information associated with different DRX group configurations to enable the first network entity 805 and the second network entity 810 to be coordinated as to priorities of different DRX groups that may have been configured by different network entities.

As shown by reference number 835, the first UE 815 may receive configuration information for a first group-based DRX cycle indicating one or more on durations associated with the first group-based DRX cycle. For example, the first UE 815 may receive one or more DRX cycle configurations (e.g., an access link DRX cycle configuration and/or a sidelink DRX cycle configuration). In some aspects, the first UE 815 may receive the configuration information from the first network entity 805 or the second network entity 810. In some other aspects, the first UE 815 may receive the configuration information from another network entity, such as an RU. In some aspects, the first UE 815 may be unaware of the group that the first UE 815 is included in for the group-based DRX cycle configurations. In other words, the groups may be used by the first network entity 805 and/or the second network entity 810 to configure DRX cycles for UEs included in the wireless network. However, the UEs may be unaware of the groups and may only receive the DRX cycles that are configured for the given UEs (e.g., the groups may be transparent to the UEs within the wireless network). In some other aspects, the UEs (e.g., the first UE 815 and the second UE 820) may receive an indication of the DRX group that the UEs are included in.

As shown by reference number 840, the second UE 820 may receive configuration information for a second group-based DRX cycle indicating one or more on durations associated with the second group-based DRX cycle. For example, the second UE 820 may receive one or more DRX cycle configurations (e.g., an access link DRX cycle configuration and/or a sidelink DRX cycle configuration). In some aspects, the second UE 820 may receive the configuration information from the first network entity 805 or the second network entity 810. In some other aspects, the second UE 820 may receive the configuration information from another network entity, such as an RU.

As described above, the first UE 815 and the second UE 820 may be included in different DRX groups. As a result, the configured on durations for the DRX cycles of the first UE 815 and the second UE 820 may not be aligned. The first UE 815 and the second UE 820 may establish a sidelink connection. In order to align DRX cycles for the first UE 815 and the second UE 820 (e.g., that are included in different DRX groups and are communicating with one another) one or more added on durations may be configured for the first UE 815 and/or the second UE 820 to facilitate DRX cycle alignment between the first UE 815 and/or the second UE 820. As used herein, an “added on duration” may refer to an on duration of a DRX cycle that is in addition to on durations configured for other UEs in the same DRX group. For example, UEs included in the same DRX group may be configured with periodic on durations (e.g., in a similar manner as described in more detail elsewhere herein). In some aspects, a UE included in the DRX group may have an added on duration to facilitate DRX alignment with another UE that the UE is communicating with (e.g., where the other UE is included in a different DRX group).

For example, as shown by reference number 845, the first UE 815 may communicate (e.g., transmit and/or receive sidelink communications), with the second UE 820, during an added on duration that is not included in the one or more on durations associated with the first group-based DRX cycle, where the added on duration at least partially overlaps with an on duration associated with the second UE 820. In some aspects, the added on duration may be associated with an access link (e.g., a Uu link) DRX cycle. In some other aspects, the added on duration may be associated with a sidelink DRX cycle. In some aspects, the added on duration and the on duration associated with the second UE 820 may be associated with different types of links. For example, the added on duration may be associated with an access link (e.g., a Uu link) and the on duration associated with the second UE 820 may be associated with a sidelink. Conversely, the added on duration may be associated with a sidelink and the on duration associated with the second UE 820 may be associated with an access link (e.g., a Uu link).

For example, the added on duration may be a sidelink on duration, and the on duration associated with the second UE 820 may be an access link on duration. In such examples, the first UE 815 may receive, and the second UE 820 may transmit, a sidelink message during the added on duration. In other words, in some examples, a receiving UE (e.g., a UE receiving sidelink communications) may be associated with adding a sidelink on duration to facilitate alignment with an access link (e.g., Uu link) on duration of a transmitting UE (e.g., a UE transmitting sidelink communications). As another example, the added on duration may be an access link on duration, and the on duration associated with the second UE 820 may be a sidelink on duration. In such examples, the first UE 815 may transmit, and the second UE 820 may receive, a sidelink message during the added on duration. In other words, in some examples, a transmitting UE may be associated with added access link (e.g., a Uu link) on durations to facilitate alignment with sidelink on durations of a receiving UE. In other words, if UEs are in different DRX groups, at least one of the UEs may be associated with adding a sidelink on duration or an access link on duration so that the transmitting UEs' Uu on duration at least partially overlaps (e.g., in the time domain) with the receiving UEs' sidelink on duration.

In some aspects, two UEs that are communicating with one another may each add sidelink on durations aligning with (e.g., at least partially overlapping in the time domain with) access link (e.g., Uu link) on durations of the other UE. For example, the first UE 815 may be associated with added sidelink on durations that correspond to or align with each access link on duration of the second UE 820. Additionally, or alternatively, the second UE 820 may be associated with added sidelink on durations that correspond to, or align with, each access link on duration of the first UE 815. As another example, two UEs that are communicating with one another may each add access link (e.g., Uu link) on durations aligning with (e.g., at least partially overlapping in the time domain with) sidelink on durations of the other UE. For example, the first UE 815 may be associated with added access link on durations that correspond to or align with each sidelink on duration of the second UE 820. Additionally, or alternatively, the second UE 820 may add access link on durations that correspond to or align with each sidelink on duration of the first UE 815.

For example, as shown in FIG. 8B and by reference number 850, the first UE 815 and the second UE 820 may have group-configured on durations (e.g., on durations that are configured for respective DRX groups of the first UE 815 and the second UE 820). For example, as shown in FIG. 8B, the access link (e.g., Uu link) and sidelink on durations for the group-configured on durations may be aligned (e.g., access link (e.g., Uu link) and sidelink on durations may be aligned for a given DRX group). However, because the first UE 815 and the second UE 820 are included in different DRX groups, there may not be DRX alignment between the first UE 815 and the second UE 820. Therefore, as shown by reference number 855, the first UE 815 and the second UE 820 may be associated with added on durations to facilitate DRX alignment among the first UE 815 and the second UE 820. For example, as shown in FIG. 8B, the first UE 815 may be associated with added access link (e.g., Uu link) on durations to align with (e.g., at least partially overlap, or completely overlap, in the time domain) sidelink on durations of the second UE 820. Additionally, the second UE 820 may be associated with added access link on durations to align with sidelink on durations of the first UE 815. In other example, the first UE 815 may be associated with added sidelink on durations to align with (e.g., at least partially overlap, or completely overlap, in the time domain) access link on durations of the second UE 820. In such examples, the second UE 820 may be associated with added sidelink on durations to align with access link on durations of the first UE 815. In this way, access link (e.g., Uu link) and sidelink on durations of the first UE 815 and the second UE 820 may at least partially overlap in the time domain. As a result, a delay between a UE (e.g., the first UE 815 or the second UE 820) receiving a sidelink grant (e.g., via an access link during an access link on duration) and transmitting the sidelink message indicated by the sidelink grant (e.g., during a sidelink on duration of the other UE) may be reduced.

In some aspects, when two UEs are communicating with one another, the UE associated with the lower priority (e.g., among the two UEs) may be associated with added one or more on durations. In other words, when two UEs that are included in different DRX groups are communicating with one another, the UE associated with the lower priority (or included in the DRX group associated with the lower priority) may accommodate the UE associated with the higher priority (e.g., the lower priority UE may be associated with added on durations to facilitate DRX alignment with the higher priority UE). For example, the first UE 815 may be associated with a lower priority than the second UE 820 (e.g., the first UE 815 may be included in a DRX group having a lower priority than a DRX group of the second UE 820). Therefore, the first UE 815 may be associated with added one or more on durations (e.g., a Uu on duration or a sidelink on duration) to facilitate DRX alignment with the second UE 820. For example, the first UE 815 may be included in a first DRX group and the second UE 820 may be included in a second DRX group. The first UE 815 communicating with the second UE 820 during the added on duration (e.g., added for the first UE 815) may be based at least in part on the second DRX group being associated with a higher priority than the first DRX group.

For example, as shown in FIG. 8C and by reference number 850, the first UE 815 and the second UE 820 may have group-configured on durations (e.g., on durations that are configured for respective DRX groups of the first UE 815 and the second UE 820), in a similar manner as described above and depicted in FIG. 8B. In the example depicted in FIG. 8C, the first UE 815 may be associated with a lower priority than the second UE 820. For example, the first UE 815 may be included in a first DRX group and the second UE 820 may be included in a second DRX group. The second DRX group may be associated with a higher priority than the first DRX group. Therefore, as shown by reference number 860, the first UE 815 may be associated with one or more added on durations to facilitate DRX alignment with the second UE 820. For example, in some aspects, the first UE 815 may be associated with added access link (e.g., Uu link) on durations that align with (e.g., partially, or fully, overlap in the time domain) sidelink on durations of the second UE 820. In some aspects, the first UE 815 may be associated with added sidelink on durations that align with access link on durations of the second UE 820. In some aspects, the first UE 815 may be associated with both added access link on durations and added sidelink on durations (e.g., as depicted in FIG. 8C). As shown in FIG. 8C, the second UE 820 may not be associated with any added on durations to facilitate DRX alignment with the first UE 815. In other words, the higher priority UE may not have added on durations to facilitate DRX alignment with the lower priority UE. This may conserve resources and/or reduce power usage for higher priority UEs while still enabling DRX alignment for UEs included in different DRX groups. In this way, access link (e.g., Uu link) and sidelink on durations of the first UE 815 and the second UE 820 may at least partially overlap in the time domain. As a result, a delay between a UE (e.g., the first UE 815 or the second UE 820) receiving a sidelink grant (e.g., via an access link during an access link on duration) and transmitting the sidelink message indicated by the sidelink grant (e.g., during a sidelink on duration of the other UE) may be reduced.

In some aspects, the added on durations may be configured by the first network entity 805 and/or the second network entity 810. For example, for UEs having an established sidelink connection that are in different DRX groups, the first network entity 805 and/or the second network entity 810 may configure added on durations for a DRX cycle of at least one of the UEs (e.g., in a similar manner as described above). In other words, in some aspects, an added on duration may be not added by the UE. Rather, the first network entity 805 and/or the second network entity 810 may configure the added on durations for UEs in different DRX groups that are communicating with one another to facilitate DRX alignment among the UEs (e.g., in a similar manner as described in more detail elsewhere herein). For example, the first network entity 805 and/or the second network entity 810 may align added on durations (e.g., in the time domain) for the first UE 815 with on durations associated with the second UE 820 (e.g., in a similar manner as described in more detail elsewhere herein).

The added on durations may be included in the DRX configuration transmitted to the first UE 815 and/or the second UE 820. In other examples, the added on durations may be indicated to the first UE 815 and/or the second UE 820 in a different message (e.g., in a radio resource control (RRC) message, a medium access control (MAC) control element (MAC-CE) message, or a DCI message, among other examples). For example, the first network entity 805 and/or the second network entity 810 may transmit an indication of an added on duration for a UE. For example, the first network entity 805 may transmit, to the second network entity 810, the indication of an added on duration for the first UE 815 (e.g., when the first network entity 805 is a base station, a CU, or a DU). As another example, the first network entity 805 may transmit, to the first UE 815, the indication of an added on duration for the first UE 815 (e.g., when the first network entity 805 is a base station or an RU).

In some other aspects, the on durations may be added by the first UE 815 and/or the second UE 820 (e.g., with or without receiving an indication to add the on durations from a network entity). For example, when establishing a sidelink connection between the first UE 815 and the second UE 820, the first UE 815 and the second UE 820 may exchange information associated with one or more DRX cycles configured for each UE. Based at least in part on the exchange of information associated with one or more DRX cycles configured for each UE, the first UE 815 and/or the second UE 820 may identify one or more added on durations to facilitate DRX alignment between the first UE 815 and/or the second UE 820. Additionally, the first UE 815 and/or the second UE 820 may identify which UE, from first UE 815 and the second UE 820, is to add the on durations (e.g., based at least in part on a priority of the first UE 815 and the second UE 820 or a priority of DRX groups associated with first UE 815 and the second UE 820).

As a result, latency associated with sidelink communications between the UEs may be decreased because the added on duration may enable a sidelink grant and a sidelink communication to be transmitted or received during the same on duration. Additionally, the transmission of sidelink communications may occur during an on duration for each UE, thereby eliminating the need for at least one of the UEs to transition out of a sleep state or an inactive state to transmit or receive the sidelink communication(s).

As indicated above, FIGS. 8A-8C are provided as examples. Other examples may differ from what is described with regard to FIGS. 8A-8C.

FIG. 9 is a diagram illustrating an example process 900 performed, for example, by a first UE, in accordance with the present disclosure. Example process 900 is an example where the first UE (e.g., UE 120, the first UE 815, or the second UE 820) performs operations associated with DRX cycle alignment.

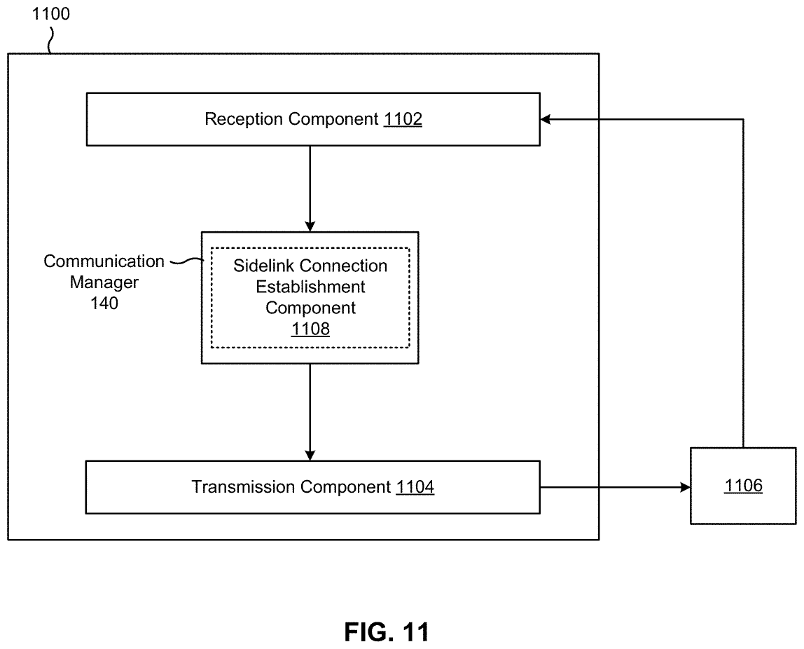

As shown in FIG. 9, in some aspects, process 900 may include receiving, from a network entity, configuration information for a group-based DRX cycle indicating one or more on durations associated with the group-based DRX cycle (block 910). For example, the first UE (e.g., using communication manager 140 and/or reception component 1102, depicted in FIG. 11) may receive, from a network entity, configuration information for a group-based DRX cycle indicating one or more on durations associated with the group-based DRX cycle, as described above, for example, with reference to FIGS. 8A-8C (e.g., and reference numbers 835 and/or 840).

As further shown in FIG. 9, in some aspects, process 900 may include communicating, with a second UE, during an added on duration that is not included in the one or more on durations associated with the group-based DRX cycle, wherein the added on duration at least partially overlaps with an on duration associated with the second UE (block 920). For example, the first UE (e.g., using communication manager 140 and/or transmission component 1104 or reception component 1102, depicted in FIG. 11) may communicate, with a second UE, during an added on duration that is not included in the one or more on durations associated with the group-based DRX cycle, wherein the added on duration at least partially overlaps with an on duration associated with the second UE, as described above, for example, with reference to FIGS. 8A-8C (e.g., and reference number 845).

Process 900 may include additional aspects, such as any single aspect or any combination of aspects described below and/or in connection with one or more other processes described elsewhere herein.

In a first aspect, the first UE is included in a first group associated with the group-based DRX cycle and the second UE is included in a second group associated with the group-based DRX cycle.

In a second aspect, alone or in combination with the first aspect, the added on duration is associated with a first link type, from a sidelink or an access link, and the on duration associated with the second UE is associated with a second link type, from the sidelink or the access link.

In a third aspect, alone or in combination with one or more of the first and second aspects, the added on duration is a sidelink on duration, and the on duration associated with the second UE is an access link on duration.

In a fourth aspect, alone or in combination with one or more of the first through third aspects, communicating with the second UE includes receiving a sidelink message during the added on duration.

In a fifth aspect, alone or in combination with one or more of the first through fourth aspects, the added on duration is an access link on duration, and the on duration associated with the second UE is a sidelink on duration.

In a sixth aspect, alone or in combination with one or more of the first through fifth aspects, communicating with the second UE includes transmitting a sidelink message during the added on duration.

In a seventh aspect, alone or in combination with one or more of the first through sixth aspects, process 900 includes receiving, from the network entity, an indication of the added on duration.

In an eighth aspect, alone or in combination with one or more of the first through seventh aspects, process 900 includes establishing, with the second UE, a sidelink connection, wherein establishing the sidelink connection includes receiving an indication of the on duration associated with the second UE.

In a ninth aspect, alone or in combination with one or more of the first through eighth aspects, the first UE is included in a first group associated with the group-based DRX cycle and the second UE is included in a second group associated with the group-based DRX cycle, and communicating with the second UE during the added on duration is based at least in part on the second group being associated with a higher priority than the first group.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., the first network entity 805, the second network entity 810, the base station 110, a CU, a DU, and/or an RU) performs operations associated with DRX cycle alignment.

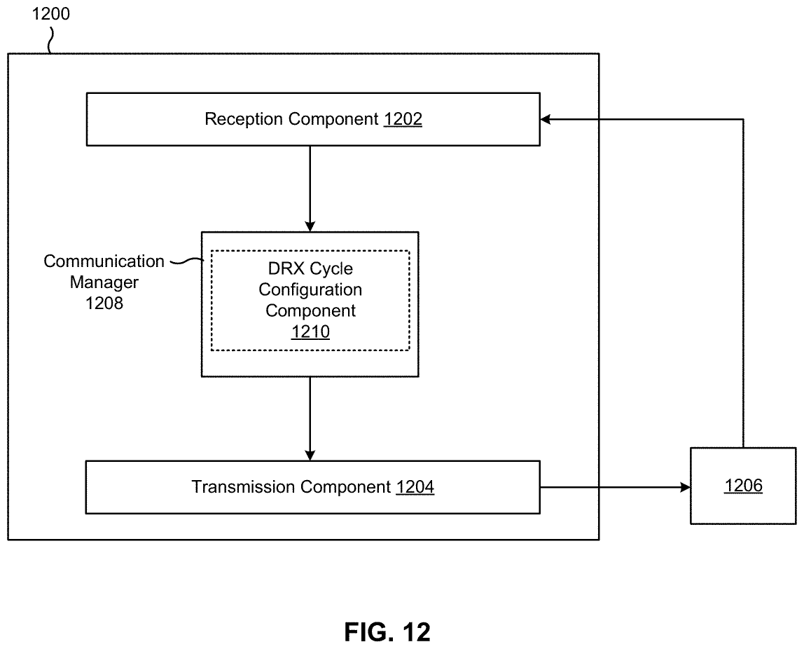

As shown in FIG. 10, in some aspects, process 1000 may include configuring, for a first group of UEs, a first group-based DRX cycle indicating one or more on durations associated with the first group-based DRX cycle (block 1010). For example, the network entity (e.g., using communication manager 150, communication manager 1208, and/or DRX cycle configuration component 1210, depicted in FIG. 12) may configure, for a first group of UEs, a first group-based DRX cycle indicating one or more on durations associated with the first group-based DRX cycle, as described above, for example, with reference to FIGS. 8A-8C (e.g., and reference number 825).

As further shown in FIG. 10, in some aspects, process 1000 may include transmitting an indication of an added on duration for a UE, included in the first group of UEs, that is not included in the one or more on durations associated with the first group-based DRX cycle, wherein the added on duration at least partially overlaps with an on duration associated with a second group-based DRX cycle (block 1020). For example, the network entity (e.g., using communication manager 150, communication manager 1208, and/or transmission component 1204, depicted in FIG. 12) may transmit an indication of an added on duration for a UE, included in the first group of UEs, that is not included in the one or more on durations associated with the first group-based DRX cycle, wherein the added on duration at least partially overlaps with an on duration associated with a second group-based DRX cycle, as described above, for example, with reference to FIGS. 8A-8C (e.g., and reference numbers 825, 830, 835, and/or 840).

Process 1000 may include additional aspects, such as any single aspect or any combination of aspects described below and/or in connection with one or more other processes described elsewhere herein.

In a first aspect, process 1000 includes receiving, from another network entity, an indication of the second group-based DRX cycle and one or more on durations, including the on duration, associated with the second group-based DRX cycle.

In a second aspect, alone or in combination with the first aspect, the added on duration is associated with a first link type, from a sidelink or an access link, and the on duration associated with the second group-based DRX cycle is associated with a second link type, from the sidelink or the access link.

In a third aspect, alone or in combination with one or more of the first and second aspects, the added on duration is a sidelink on duration, and the on duration associated with the second group-based DRX cycle is an access link on duration.

In a fourth aspect, alone or in combination with one or more of the first through third aspects, the added on duration is an access link on duration, and the on duration associated with the second group-based DRX cycle is a sidelink on duration.

In a fifth aspect, alone or in combination with one or more of the first through fourth aspects, transmitting the indication of the added on duration for the UE is based at least in part on the second group-based DRX cycle being associated with a higher priority than the first group-based DRX cycle.

In a sixth aspect, alone or in combination with one or more of the first through fifth aspects, configuring the first group-based DRX cycle comprises aligning first on durations associated with a sidelink with first on durations associated with an access link for the first group of UEs.

In a seventh aspect, alone or in combination with one or more of the first through sixth aspects, process 1000 includes aligning second on durations associated with the sidelink with second on durations associated with the access link for a second group of UEs after aligning the first on durations associated with the sidelink with the first on durations associated with the access link for the first group of UEs, based at least in part on the first group of UEs being associated with a higher priority than the second group of UEs.

In an eighth aspect, alone or in combination with one or more of the first through seventh aspects, process 1000 includes transmitting, to another network entity, information associated with the first group-based DRX cycle, where the information includes an indication of a priority associated with the first group-based DRX cycle.

In a ninth aspect, alone or in combination with one or more of the first through eighth aspects, transmitting the information associated with the first group-based DRX cycle comprises transmitting a DRX group configuration message.

In a tenth aspect, alone or in combination with one or more of the first through ninth aspects, the DRX group configuration message is an Xn-AP message.

In an eleventh aspect, alone or in combination with one or more of the first through tenth aspects, the indication of the priority associated with the first group-based DRX cycle includes an integer indicating the priority.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a sidelink connection establishment component 1108, among other examples.

In some aspects, the apparatus 1100 may be configured to perform one or more operations described herein in connection with FIGS. 8A-8C. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a network entity, configuration information for a group-based DRX cycle indicating one or more on durations associated with the group-based DRX cycle. The reception component 1102 and/or the transmission component 1104 may communicate, with a second UE, during an added on duration that is not included in the one or more on durations associated with the group-based DRX cycle, wherein the added on duration at least partially overlaps with an on duration associated with the second UE.

The transmission component 1104 may transmit a sidelink message during the added on duration, where the added on duration is an access link on duration, and the on duration associated with the second UE is a sidelink on duration.

The reception component 1102 may receive a sidelink message during the added on duration, where the added on duration is a sidelink on duration, and the on duration associated with the second UE is an access link on duration.

The reception component 1102 may receive, from the network entity, an indication of the added on duration.

The sidelink connection establishment component 1108 may establish, with the second UE, a sidelink connection, wherein establishing the sidelink connection includes receiving an indication of the on duration associated with the second UE.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the base station described in connection with FIG. 2. The communication manager 1208 may be, or be similar to, the communication manager 150 depicted in FIGS. 1 and 2. For example, in some aspects, the communication manager 1208 may be configured to perform one or more of the functions described as being performed by the communication manager 150. In some aspects, the communication manager 1208 may include the reception component 1202 and/or the transmission component 1204. The communication manager 1208 may include a DRX cycle configuration component 1210, among other examples.

In some aspects, the apparatus 1200 may be configured to perform one or more operations described herein in connection with FIGS. 8A-8C. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The DRX cycle configuration component 1210 may configure, for a first group of UEs, a first group-based DRX cycle indicating one or more on durations associated with the first group-based DRX cycle. The transmission component 1204 may transmit an indication of an added on duration for a UE, included in the first group of UEs, that is not included in the one or more on durations associated with the first group-based DRX cycle, wherein the added on duration at least partially overlaps with an on duration associated with a second group-based DRX cycle.

The reception component 1202 may receive, from another network entity, an indication of the second group-based DRX cycle and one or more on durations, including the on duration, associated with the second group-based DRX cycle.

The DRX cycle configuration component 1210 may align second on durations associated with the sidelink with second on durations associated with the access link for a second group of UEs after aligning the first on durations associated with the sidelink with the first on durations associated with the access link for the first group of UEs, based at least in part on the first group of UEs being associated with a higher priority than the second group of UEs.

The transmission component 1204 may transmit, to another network entity, information associated with the first group-based DRX cycle, wherein the information includes an indication of a priority associated with the first group-based DRX cycle.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first user equipment (UE), comprising: receiving, from a network entity, configuration information for a group-based discontinuous reception (DRX) cycle indicating one or more on durations associated with the group-based DRX cycle; and communicating, with a second UE, during an added on duration that is not included in the one or more on durations associated with the group-based DRX cycle, wherein the added on duration at least partially overlaps with an on duration associated with the second UE.

Aspect 2: The method of Aspect 1, wherein the first UE is included in a first group associated with the group-based DRX cycle and the second UE is included in a second group associated with the group-based DRX cycle.

Aspect 3: The method of any of Aspects 1-2, wherein the added on duration is associated with a first link type, from a sidelink or an access link, and the on duration associated with the second UE is associated with a second link type, from the sidelink or the access link.

Aspect 4: The method of any of Aspects 1-3, wherein the added on duration is a sidelink on duration, and wherein the on duration associated with the second UE is an access link on duration.

Aspect 5: The method of Aspect 4, wherein communicating with the second UE comprises: receiving a sidelink message during the added on duration.

Aspect 6: The method of any of Aspects 1-3, wherein the added on duration is an access link on duration, and wherein the on duration associated with the second UE is a sidelink on duration.

Aspect 7: The method of Aspect 6, wherein communicating with the second UE comprises: transmitting a sidelink message during the added on duration.

Aspect 8: The method of any of Aspects 1-7, further comprising: receiving, from the network entity, an indication of the added on duration.

Aspect 9: The method of any of Aspects 1-8, further comprising: establishing, with the second UE, a sidelink connection, wherein establishing the sidelink connection includes receiving an indication of the on duration associated with the second UE.

Aspect 10: The method of any of Aspects 1-9, wherein the first UE is included in a first group associated with the group-based DRX cycle and the second UE is included in a second group associated with the group-based DRX cycle, and wherein communicating with the second UE during the added on duration is based at least in part on the second group being associated with a higher priority than the first group.

Aspect 11: A method of wireless communication performed by a network entity, comprising: configuring, for a first group of user equipments (UEs), a first group-based discontinuous reception (DRX) cycle indicating one or more on durations associated with the first group-based DRX cycle; and transmitting an indication of an added on duration for a UE, included in the first group of UEs, that is not included in the one or more on durations associated with the first group-based DRX cycle, wherein the added on duration at least partially overlaps with an on duration associated with a second group-based DRX cycle.

Aspect 12: The method of Aspect 11, further comprising: receiving, from another network entity, an indication of the second group-based DRX cycle and one or more on durations, including the on duration, associated with the second group-based DRX cycle.

Aspect 13: The method of any of Aspects 11-12, wherein the added on duration is associated with a first link type, from a sidelink or an access link, and the on duration associated with the second group-based DRX cycle is associated with a second link type, from the sidelink or the access link.

Aspect 14: The method of any of Aspects 11-13, wherein the added on duration is a sidelink on duration, and wherein the on duration associated with the second group-based DRX cycle is an access link on duration.

Aspect 15: The method of any of Aspects 11-13, wherein the added on duration is an access link on duration, and wherein the on duration associated with the second group-based DRX cycle is a sidelink on duration.

Aspect 16: The method of any of Aspects 11-15, wherein transmitting the indication of the added on duration for the UE is based at least in part on the second group-based DRX cycle being associated with a higher priority than the first group-based DRX cycle.

Aspect 17: The method of any of Aspects 11-16, wherein configuring the first group-based DRX cycle comprises: aligning first on durations associated with a sidelink with first on durations associated with an access link for the first group of UEs.

Aspect 18: The method of Aspect 17, further comprising: aligning second on durations associated with the sidelink with second on durations associated with the access link for a second group of UEs after aligning the first on durations associated with the sidelink with the first on durations associated with the access link for the first group of UEs, based at least in part on the first group of UEs being associated with a higher priority than the second group of UEs.

Aspect 19: The method of any of Aspects 11-18, further comprising: transmitting, to another network entity, information associated with the first group-based DRX cycle, wherein the information includes an indication of a priority associated with the first group-based DRX cycle.

Aspect 20: The method of Aspect 19, wherein transmitting the information associated with the first group-based DRX cycle comprises: transmitting a DRX group configuration message.

Aspect 21: The method of Aspect 20, wherein the DRX group configuration message is an Xn application protocol (Xn-AP) message.

Aspect 22: The method of any of Aspects 19-21, wherein the indication of the priority associated with the first group-based DRX cycle includes an integer indicating the priority.

Aspect 23: An apparatus for wireless communication at a device, comprising a processor; memory coupled with the processor; and instructions stored in the memory and executable by the processor to cause the apparatus to perform the method of one or more of Aspects 1-10.

Aspect 24: A device for wireless communication, comprising a memory and one or more processors coupled to the memory, the one or more processors configured to perform the method of one or more of Aspects 1-10.

Aspect 25: An apparatus for wireless communication, comprising at least one means for performing the method of one or more of Aspects 1-10.

Aspect 26: A non-transitory computer-readable medium storing code for wireless communication, the code comprising instructions executable by a processor to perform the method of one or more of Aspects 1-10.

Aspect 27: A non-transitory computer-readable medium storing a set of instructions for wireless communication, the set of instructions comprising one or more instructions that, when executed by one or more processors of a device, cause the device to perform the method of one or more of Aspects 1-10.

Aspect 28: An apparatus for wireless communication at a device, comprising a processor; memory coupled with the processor; and instructions stored in the memory and executable by the processor to cause the apparatus to perform the method of one or more of Aspects 11-22.

Aspect 29: A device for wireless communication, comprising a memory and one or more processors coupled to the memory, the one or more processors configured to perform the method of one or more of Aspects 11-22.

Aspect 30: An apparatus for wireless communication, comprising at least one means for performing the method of one or more of Aspects 11-22.

Aspect 31: A non-transitory computer-readable medium storing code for wireless communication, the code comprising instructions executable by a processor to perform the method of one or more of Aspects 11-22.

Aspect 32: A non-transitory computer-readable medium storing a set of instructions for wireless communication, the set of instructions comprising one or more instructions that, when executed by one or more processors of a device, cause the device to perform the method of one or more of Aspects 11-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
receive, from a network entity, configuration information for a group-based discontinuous reception (DRX) cycle indicating one or more on durations associated with the group-based DRX cycle; and
communicate, with a second UE, during an added on duration that is not included in the one or more on durations associated with the group-based DRX cycle, wherein the added on duration at least partially overlaps with an on duration associated with the second UE.

2. The first UE of claim 1, wherein the first UE is included in a first group associated with the group-based DRX cycle and the second UE is included in a second group associated with the group-based DRX cycle.

3. The first UE of claim 1, wherein the added on duration is associated with a first link type, from a sidelink or an access link, and the on duration associated with the second UE is associated with a second link type, from the sidelink or the access link.

4. The first UE of claim 1, wherein the added on duration is a sidelink on duration, and wherein the on duration associated with the second UE is an access link on duration.

5. The first UE of claim 4, wherein the one or more processors, to communicate with the second UE, are configured to:
receive a sidelink message during the added on duration.

6. The first UE of claim 1, wherein the added on duration is an access link on duration, and wherein the on duration associated with the second UE is a sidelink on duration.

7. The first UE of claim 6, wherein the one or more processors, to communicate with the second UE, are configured to:
transmit a sidelink message during the added on duration.

8. The first UE of claim 1, wherein the one or more processors are further configured to:
receive, from the network entity, an indication of the added on duration.

9. The first UE of claim 1, wherein the one or more processors are further configured to:
establish, with the second UE, a sidelink connection, wherein establishing the sidelink connection includes receiving an indication of the on duration associated with the second UE.

10. The first UE of claim 1, wherein the first UE is included in a first group associated with the group-based DRX cycle and the second UE is included in a second group associated with the group-based DRX cycle, and
wherein communicating with the second UE during the added on duration is based at least in part on the second group being associated with a higher priority than the first group.

11. A network entity for wireless communication, comprising:
a memory; and
one or more processors, coupled to the memory, configured to:
configure, for a first group of user equipments (UEs), a first group-based discontinuous reception (DRX) cycle indicating one or more on durations associated with the first group-based DRX cycle; and
transmit an indication of an added on duration for a UE, included in the first group of UEs, that is not included in the one or more on durations associated with the first group-based DRX cycle, wherein the added on duration at least partially overlaps with an on duration associated with a second group-based DRX cycle.

12. The network entity of claim 11, wherein transmitting the indication of the added on duration for the UE is based at least in part on the second group-based DRX cycle being associated with a higher priority than the first group-based DRX cycle.

13. The network entity of claim 11, wherein the one or more processors, to configure the first group-based DRX cycle, are configured to:
align first on durations associated with a sidelink with first on durations associated with an access link for the first group of UEs.

14. The network entity of claim 13, wherein the one or more processors are further configured to:
align second on durations associated with the sidelink with second on durations associated with the access link for a second group of UEs after aligning the first on durations associated with the sidelink with the first on durations associated with the access link for the first group of UEs, based at least in part on the first group of UEs being associated with a higher priority than the second group of UEs.

15. The network entity of claim 11, wherein the one or more processors are further configured to:
transmit, to another network entity, information associated with the first group-based DRX cycle, wherein the information includes an indication of a priority associated with the first group-based DRX cycle, wherein the information associated with the first group-based DRX cycle in included in a DRX group configuration message.

16. A method of wireless communication performed by a first user equipment (UE), comprising:
receiving, from a network entity, configuration information for a group-based discontinuous reception (DRX) cycle indicating one or more on durations associated with the group-based DRX cycle; and
communicating, with a second UE, during an added on duration that is not included in the one or more on durations associated with the group-based DRX cycle, wherein the added on duration at least partially overlaps with an on duration associated with the second UE.

17. The method of claim 16, wherein the first UE is included in a first group associated with the group-based DRX cycle and the second UE is included in a second group associated with the group-based DRX cycle.

18. The method of claim 16, wherein the added on duration is associated with a first link type, from a sidelink or an access link, and the on duration associated with the second UE is associated with a second link type, from the sidelink or the access link.

19. The method of claim 16, wherein the added on duration is a sidelink on duration, and wherein the on duration associated with the second UE is an access link on duration.

20. The method of claim 19, wherein communicating with the second UE comprises:
receiving a sidelink message during the added on duration.

21. The method of claim 16, wherein the added on duration is an access link on duration, and wherein the on duration associated with the second UE is a sidelink on duration.

22. The method of claim 21, wherein communicating with the second UE comprises:
transmitting a sidelink message during the added on duration.

23. The method of claim 16, further comprising:
receiving, from the network entity, an indication of the added on duration.

24. The method of claim 16, further comprising:
establishing, with the second UE, a sidelink connection, wherein establishing the sidelink connection includes receiving an indication of the on duration associated with the second UE.

25. The method of claim 16, wherein the first UE is included in a first group associated with the group-based DRX cycle and the second UE is included in a second group associated with the group-based DRX cycle, and
wherein communicating with the second UE during the added on duration is based at least in part on the second group being associated with a higher priority than the first group.

26. A method of wireless communication performed by a network entity, comprising:
configuring, for a first group of user equipments (UEs), a first group-based discontinuous reception (DRX) cycle indicating one or more on durations associated with the first group-based DRX cycle; and
transmitting an indication of an added on duration for a UE, included in the first group of UEs, that is not included in the one or more on durations associated with the first group-based DRX cycle, wherein the added on duration at least partially overlaps with an on duration associated with a second group-based DRX cycle.

27. The method of claim 26, wherein transmitting the indication of the added on duration for the UE is based at least in part on the second group-based DRX cycle being associated with a higher priority than the first group-based DRX cycle.

28. The method of claim 26, wherein configuring the first group-based DRX cycle comprises:
aligning first on durations associated with a sidelink with first on durations associated with an access link for the first group of UEs.

29. The method of claim 28, further comprising:
aligning second on durations associated with the sidelink with second on durations associated with the access link for a second group of UEs after aligning the first on durations associated with the sidelink with the first on durations associated with the access link for the first group of UEs, based at least in part on the first group of UEs being associated with a higher priority than the second group of UEs.

30. The method of claim 26, further comprising:
transmitting, to another network entity, information associated with the first group-based DRX cycle, wherein the information includes an indication of a priority associated with the first group-based DRX cycle, wherein the information associated with the first group-based DRX cycle in included in a DRX group configuration message.
